(19) United States
(12) Patent Application Publication
(10) Pub. No.: US 2021/0369423 A1
(43) Pub. Date: Dec. 2, 2021

(54) DENTAL CLEANING SYSTEM, BASE BODY, AND HOLDER FOR DENTAL FLOSS

(71) Applicant: GSTS INNOVATION GMBH, Mering (DE)

(72) Inventors: Tomás Alberto Joachim Schaefer, Dorfen (DE); Stefan Josef Gibisch, Mering (DE)

(21) Appl. No.: 16/976,793

(22) PCT Filed: Feb. 28, 2019
(86) PCT No.: PCT/EP2019/055074

§ 371 Date: Aug. 31, 2020

(30) Foreign Application Priority Data
Mar. 1, 2018 (DE) 10 2018 104 695.2
Dec. 13, 2018 (JP) 2018-233534

(51) Int. Cl. A61C 15/04; A61C 15/02; A46B 15/00

(52) U.S. Cl. CPC A61C 15/048; A46B 2200/108; A46B 15/0055; A61C 15/02

(57) ABSTRACT

A dental cleaning system (2) comprising a holder (12) for dental floss (18), which includes two mutually spaced brackets (19) and dental floss (18) held between the two brackets (19), and an, in particular U-shaped or annular, base body (1) to be slid onto a finger, which includes a recess (4) situated in the longitudinal direction (3) of the base body (1) for accommodating a fingertip. Essentially, the brackets (19) extend transversely to the longitudinal direction (3) of the base body (1). A first grip surface (9) is situated at least on each of the two sides of the base body (1), which is provided for controlling the movement of dental floss (18) in the mouth with the aid of the fingers adjacent to the base body (1). An appropriate base body (1) comprises, at least on each of the two sides of the base body (1), a first grip surface (9), which is provided for controlling the movement of dental cleaning elements, in particular dental floss (18), in the mouth with the aid of the fingers adjacent to the base body (1). An appropriate holder (12) for dental floss (18) comprises a second part (20) of a form-locking and/or force-locked fastening system (14) to be accommodated in a base body

The present invention relates to a dental cleaning system comprising a holder for dental floss, which includes two mutually spaced brackets and dental floss held between the two brackets, and comprising an, in particular U-shaped or annular, base body to be slid onto a finger, which includes a recess situated in the longitudinal direction of the base body for accommodating a fingertip.

Moreover, the invention relates to a base body for a dental cleaning system, in particular, according to one of the preceding claims, which is designed, in particular, to be U-shaped or annular in order to be slid onto a finger, and which comprises a recess situated in the longitudinal direction of the base body for accommodating a fingertip.

Moreover, the invention relates to a holder for dental floss or other dental cleaning elements for a dental cleaning system, in particular according to one of the preceding claims, and, in particular, comprising two mutually spaced brackets and dental floss held between the two brackets.

Devices for holding dental floss are sufficiently known from the related art. For example, U.S. Pat. No. 5,222,510 A describes an open ring comprising two brackets, between which dental floss is clamped. Devices of this type have proven to be impractical to handle, however.

U.S. Pat. No. 5,893,379 A describes a dental cleaning system which is guided with the aid of two fingers. This system takes up a lot of space in the oral cavity and, therefore, is difficult to handle. The two fingers also make it very difficult to keep the dental floss taut during insertion into the interdental space.

U.S. Pat. No. 5,881,745 A describes a dental cleaning system comprising a holder for dental floss, which includes two mutually spaced brackets and dental floss held between the two brackets. A base body is intended to be slid onto a finger and comprises a recess situated in the longitudinal direction of the base body for accommodating a fingertip. The base body is designed in the shape of a thimble. A second thimble or at least a part of a second thimble is provided for controlling the dental cleaning system in the mouth. The control can therefore take place using only one finger, however, and is therefore inaccurate and nevertheless takes up a lot of space in the oral cavity.

The problem addressed by the present invention is therefore that of providing a system for cleaning teeth, in particular interdental spaces, the application of which has been simplified.

The problem is solved by the features of the independent patent claims. Further advantageous embodiments result from the dependent claims and the drawings.

The invention relates to a dental cleaning system comprising a holder for dental floss. The holder of the dental cleaning system comprises two mutually spaced brackets and dental floss held between the two brackets. The dental floss is designed to be introduced into the interdental space, and so the interdental space can be cleaned. Moreover, the dental cleaning system comprises a base body, wherein the brackets are arranged at the base body.

The brackets of the holder preferably extend essentially transversely to the longitudinal direction of the base body, and so the brackets and the base body are preferably situated at an angle with respect to one another. According to a particularly preferred embodiment, a grip surface is situated on each of the two sides of the base body, which is provided for controlling the movement of the dental floss in the mouth with the aid of the fingers adjacent to the base body. The grip surfaces preferably extend in the longitudinal direction of the base body.

In an advantageous embodiment of the invention, the base body comprises a recess in the longitudinal direction for accommodating a finger tip and is preferably designed to be U-shaped or annular. The longitudinal direction of the base body preferably extents from a first recess opening up to a second recess opening, through which the finger can be guided into the recess. The recess can also comprise only one recess opening, and so the base body is essentially thimble-shaped.

In this way, the finger can be inserted into the oral cavity essentially in parallel to the masticatory surface relief and pressed downward in order to insert the dental floss into the interdental space. The grip surfaces enable the dental cleaning system to be moved and controlled in the oral cavity, and so the dental floss removes contaminants from the interdental space in a targeted manner. Preferably, the brackets extend obliquely with respect to the longitudinal direction of the base body.

A further second grip surface for controlling the movement of the dental floss in the mouth, with the aid of the thumb, is advantageously provided on the side of the base body opposite to the brackets. In addition to the lateral guidance with the aid of the two first grip surfaces, pressure can be applied onto the dental cleaning system by the index finger with the aid of this further grip surface. Closely adjacent teeth usually make it difficult to insert the dental floss into the interdental space. The controlled guidance of the dental cleaning system with the aid of the grip surfaces facilitates the introduction of the dental floss, since the pressure and the movement can take place in a targeted manner.

Yet another advantage is achieved when at least one of the grip surfaces forms a surface which is, in particular, wing-like and projects over the base body. Therefore, a preferably large grip surface for the finger is provided, without proportioning the dental cleaning system to be too large overall to be able to be comfortably positioned in the oral cavity.

It is advantageous when at least one of the grip surfaces includes a non-slip, in particular, curved, perforated, and/or ribbed surface. The feel of the grip surfaces improves the handling of the dental cleaning system, since a good hold is ensured even when the surface is possibly wet.

It is advantageous when the holder and the base body are designed as one piece or multi-pieced. The dental floss should be changed regularly, for hygiene reasons. In the case of a multi-pieced embodiment of the dental cleaning system, in particular, due to a holder of the dental floss, which is separate from the base body, it is possible to replace the holder together with the dental floss. Alternatively, the holder and the base body can be designed as one piece, wherein the dental floss is preferably detachably connected to the holder, and so the dental floss can be replaced independently of the holder. The dental cleaning system is therefore modularly designed in order to implement the replacement of the dental floss as easily as possible. In this case, the dental floss can also be fixedly connected to the dental cleaning system, of course, which is then completely discarded after every teeth cleaning.

It is an advantage when the base body comprises a slot. The slot is preferably designed for accommodating at least one part of the holder. Moreover, it is conceivable to tension the slot in such a way that the recess is enlarged or reduced in size in order to be able to adapt the dental cleaning system to different finger sizes.

A fastening system advantageously connects the holder and the base body to one another. Due to the fastening system, the holder and the base body can be detachably connected to one another.

It is advantageous when the holder and the base body each comprise a part of the fastening system. The two part are designed to be complementary to one another in such a way that the dental floss held by the holder is pre-tensioned when the holder and the base body are connected to one another.

Moreover, it is advantageous when the fastening system has a form-locking and/or force-locked connection. Preferably, the fastening system comprises a fastening rail and a fastening carriage, wherein the fastening rail is situated on the holder and the fastening carriage is situated on the base body. The fastening carriage can also be situated on the holder and the fastening rail can also be situated on the base body. Moreover, the fastening system can have a magnetic, threaded, plug-in, rotary, adhesive, or hook and loop connection, and/or a snap-in connection, and so the holder and the base body can be detachably connected to one another.

It is an advantage when a releasable locking mechanism secures the connection between the holder and the base body. The locking mechanism can be situated, on the one hand, on the holder and, on the other hand, on the base body. When the locking mechanism is secured, it is ensured, in particular, during the application in the oral cavity, that the holder cannot be separated from the base body. In this way, it is ensured that neither the holder nor the base body can be swallowed.

The fastening rail and the fastening carriage advantageously taper conically in the longitudinal and/or transverse direction of the base body. Due to the conical design of the fastening rail and of the fastening carriage, they can be connected to one another in a guided manner. Moreover, it is possible to establish the tension of the dental floss by way of the selected insertion pressure. The further the fastening carriage is introduced into the fastening rail and, therefore, the smaller the remaining taper portion essentially is, the more tightly the dental floss is tensioned between the brackets. The angled guidance provides an increased pretension.

Moreover, it is advantageous when the fastening rail and/or the fastening carriage comprise/comprises lateral, in particular, U-shaped and/or dovetail-shaped guide surfaces.

It is advantageous when the guide surfaces of the fastening rail and of the fastening carriage are not parallel to one another in the non-assembled state, and so the holder, which is connected to the base body, is spread apart in the assembled state in such a way that the dental floss is tensioned between the brackets.

It is an advantage when a retaining element, in particular, a thread, safeguards the holder and/or the base body against being swallowed.

A stop is advantageously situated on the holder and/or on the base body, in an area between the two brackets, the dental floss, and the base body, and so the depth of the introduction of the dental floss into an interdental space is limited in a vertical direction. The stop is selected in such a way that the dental floss preferably cannot or can only slightly come into contact with the gums, and so bleeding of the gums and injuries are prevented. The height of the stop can vary depending on the group of persons for whom the dental cleaning system is intended.

Due to the stop, the distance of the dental floss from the stop is defined and, therefore, the depth of the introduction of the dental floss into an interdental space is limited in a vertical direction. The length of the brackets and/or the arrangement or height of the stop are/is selected in such a way that the distance is different depending on the depth of the interdental space to be cleaned, and so preferably no injury of the gums takes place.

Since the tooth lengths of the persons to be treated can be very different, an injury of the gums is very frequently caused, in conventional systems, when the dental floss passes all the way through to the gums. Due to an establishment of the distance between the dental floss and the stop, the depth is established, namely how far the dental floss can penetrate the interdental space from the top side of the tooth. As soon as the stop impacts the top side of the tooth, the dental floss is also stopped. Ideally, this is the case immediately before the dental floss reaches the gums. The distance between the dental floss and the stop can either be predefined by way of the structural dimensions, or also can be set by way of the design. In this way, for example, dental cleaning systems can be made available, which predefine a certain distance. This distance can vary depending on the selection of the user for a dental cleaning system having a certain distance. Depending on the embodiment of the invention, it is also possible that this distance is adjustable, so that each user can set this distance as necessary.

In an advantageous embodiment of the invention, the stop is arranged in an area between the two brackets. This area can be directly under the dental floss, but also laterally offset with respect thereto. It is essential that the stop acts on the tooth surface and, in the process, stops the penetration of the dental floss into the interdental space.

It is advantageous when the stop is formed by the surface of the base body or of the holder opposite to the dental floss and the depth of the introduction is determined by the length of the brackets and/or the height of the stop. The length of the brackets is preferably established by the area, which extends from the fastening area of the dental floss up to the stop. When the stop is formed by the surface of the base body opposite to the dental floss, the holder and the base body are preferably designed as one piece. Alternatively, an inner side of the holder located between the brackets can establish the stop. The height of the stop can be established either by way of the appropriate, different arrangement of the stop at the holder or the base body. It is also possible, however, that the overall height of various stops is differently designed in each case, so that, as a result thereof as well, the distance between the stop, i.e., the surface that impacts the top side of the tooth, and the dental floss can be varied. As a result, for example, a set can be made available, which predefines various distances for the different users in a customized manner.

A setting of the length of the brackets and/or the height of the stop can take place, in particular, via a translatory or rotatory movability of the brackets and/or of the stop. As a result, for example, due to a telescopic displacement of the brackets or of the stop, the distance between the dental floss and the stop can be changed and, therefore, set with respect to the individual needs of the user. Alternatively or additionally, it is also possible to rotate the brackets or the stop and, as a result, change the distance between the dental floss and the stop, for example, with the aid of an oblique surface or a screw thread. This has the advantage that different components do not have to be made available for various bracket lengths or heights of the stop, since the individual components are designed to be adjustable per se.

Preferably, the stop is part of the fastening system. In particular, a centering pin of the fastening system can form the stop. As a result, a dual function can be designed for the centering pin. On the one hand, it enables the fastening system to quickly and reliably establish a connection between the base body and the holder. On the other hand, it forms the stop itself and, due to a different embodiment of the length of the centering pin, different distances between the stop or the centering pin and the dental floss can be defined.

In an advantageous embodiment of the invention, if the stop is arranged at a part of the fastening system, in particular a centering pin, the fastening system is utilized not only for connecting the base body and the holder, but rather is also provided for fastening the stop. The stop can comprise, for example, an opening, which corresponds to the centering pin and whereby the stop can be inserted onto the centering pin.

Preferably, a locking mechanism is provided, in order to lock the adjustable length of the brackets and/or the adjustable height of the stop. As a result, it is ensured that the set position of the brackets and/or of the stop does not autonomously change during the use of the dental floss. Such a locking mechanism is advantageous, in particular, during a translatory or rotatory displacement of the brackets and/or of the stop.

The holder and/or the base body advantageously comprise/comprises a fastening element for fastening dental floss. The fastening element can be designed in the shape of a cone, for example, and can be equipped with a clamping slot, and so the ends of the dental floss can be wound around the fastening element several times and fixed in the clamping slot. It is also conceivable that the clamping slot is formed in the brackets themselves, and so the dental floss is clamped directly into the brackets.

In order to designate a certain size of the holder and/or of the base body and/or of a certain dental floss, it is advantageous when the holder and/or the base body and/or the stop comprise/comprises a coding, in particular a color coding. Dental cleaning systems intended for children can include motifs, for example, whereby the dental cleaning system may become more attractive for children. It is also conceivable to select different colors of the base body and/or the holder depending on the finger size for which the dental cleaning system is designed.

Preferably, the holder (12) and/or the base body (1) and/or the stop (26) are/is manufactured from a renewable and, in particular, consumable raw material or bio-compostable material. Therefore, on the one hand, an excessive consumption of plastic is reduced and, in addition, the risk of an injury to the user is avoided in the event of inadvertent swallowing. In addition, it is possible that an incentive to use the dental cleaning system is created, specifically, for example, for use by children, by way of the fact that the user can consume the dental cleaning system or at least parts thereof after having cleaned the interdental space.

In a particularly preferred embodiment of the dental cleaning system, the distance of the dental floss from the stop is less than 12 mm, very preferably less than 8 mm. In this dimension range, the individual depths of the interdental spaces can be addressed in an optimal manner. This is the case, in particular, when the dental floss is already tensioned between the brackets before it is introduced into the interdental space. Although the dental floss is tensioned, at the latest, upon overcoming the contact point of two adjacent teeth, after the contact point has been overcome, the dental floss largely assumes the tension of its original state again. Therefore, if the dental floss was previously arranged between the brackets in a slack manner, the distance of the dental floss from the stop must be relatively great, in order to overcome the contact point before the stop is reached. Thereafter, this distance is too great again, however, in order to not damage the gums. If the dental floss is already tensioned in the initial state, this distance can be very precisely predetermined. Only the elasticity of the dental floss and, if necessary, a bending of the brackets are also to be taken into account in this case, in order to be able to determine the correct distance of the dental floss from the stop for a certain depth of the interdental space. Ideally, the contact point is overcome without the stop having been reached and in such a way that, thereafter, the distance between the dental floss and the stop is such that the gums are not injured.

Typically, the depth of an interdental space of an adult person is less than 10 mm and that of a child is even less than 5 mm. An appropriate height of the stop or length of the brackets therefore creates a particularly gentle cleaning of the interdental space without injuring the gums.

Advantageously, the ratio of the distance of the dental floss from the stop with respect to an effective length of the dental floss is less than or equal to 0.5. This means, for example, at an effective length of the dental floss of 20 mm, the distance of the dental floss from the stop is at most 10 mm. With this ratio, a good tension can be introduced into the dental floss in relation to its deflection and relaxation after overcoming the contact point and, after overcoming the contact point, the dental floss does not pass all the way through to the gums.

The invention also relates to a base body for a dental cleaning system. The dental cleaning system is preferably designed according to the preceding description or the following description.

The base body is designed, in particular, to be U-shaped or annular in order to be slid onto a finger and comprises a recess situated in the longitudinal direction of the base body for accommodating a fingertip. The recess preferably extends from a first recess opening to a second recess opening. It is also conceivable that the recess comprises only one recess opening, and so the base body is essentially thimble-shaped. The longitudinal direction basically extends through the center of the recess or in parallel to its axis of symmetry.

A grip surface is situated at least on each of the two sides of the base body, which is provided for controlling the movement of dental floss in the mouth with the aid of the fingers adjacent to the base body. The grip surface preferably extends in the longitudinal direction. As a result, it is possible to control the base body and, therefore, the entire dental cleaning system essentially in three dimensions. The movement control takes place in a tactile manner. Preferably, the two grip surfaces are operated by the thumb and the middle finger, and so the index finger stabilizes and the pressing, thrusting, and twisting movements can be enhanced. When the base body and the dental cleaning system are introduced into the oral cavity, the grip surfaces are preferably oriented on the base body in the direction of the mouth. The grip surfaces therefore preferably project over the base body in the longitudinal direction.

In this case, it is an advantage when a second grip surface is provided between the two lateral first grip surfaces for controlling the movement of the dental floss in the mouth with the aid of the thumb. The index finger preferably engages on the second grip surface in order to apply pressure onto the base body, and so the dental floss of the dental cleaning system can be introduced into the interdental space and guided.

It is also advantageous when at least the two lateral grip surfaces form a surface which is, in particular, wing-like and/or projects over the base body. As a result, the fingers can ergonomically grip the base body.

Advantageously, a first part of a form-locking and/or force-locked fastening system for accommodating a holder for dental floss is formed on the base body for connecting the base body to a holder for dental floss. The part of the fastening system is preferably a fastening rail or a fastening carriage, a part of a magnetic, threaded, plug-in, rotary, adhesive, or hook and loop connection, and/or a part of a snap-in connection.

Preferably, a stop is arranged at the first part of the fastening system. As a result, the fastening system for the holder can be simultaneously utilized for fastening the stop. A simple design and manufacture is possible as a result.

A stop is arranged at the base body in an area at which two brackets can be arranged in order to hold the dental floss, and so the depth of the introduction of the dental floss into an interdental space is limited in a vertical direction. In the case of a one-pieced system, a stable fastening of the stop at the base body can take place. In the case of a two-pieced system, it is very particularly advantageous when the stop is arranged at the base body. In this way, for example, due to a combination with a holder for the dental floss, which has different bracket lengths, a different depth of the working range of the dental floss can be achieved. On the other hand, it is also possible to make different base bodies available for identical holders for the dental floss, which each have a different stop or a different stop height.

It is advantageous when the recess is designed to be conical and/or flattened, and so the cleaning system can be held on the finger in a rotatably fixed manner. Preferably, the first recess opening is larger than the second recess opening, and so an inner surface of the recess conically tapers. In order to be able to hold the base body on the finger in a rotatably fixed manner, the inner surface of the recess can be formed from several surface segments situated at an angle with respect to one another.

It is advantageous when the base body includes a slot, in particular, for accommodating the holder and/or for adaptation to different finger sizes. The slot preferably extends in the longitudinal direction of the base body. It is conceivable that the base body comprises multiple slots and, therefore, is flexibly designed in order to be adaptable to different finger sizes.

The base body is advantageously U-shaped or is designed, on its periphery, as a closed ring or an open ring and/or as a thimble.

The invention also relates to a holder for dental floss for a dental cleaning system. The dental cleaning system is preferably designed according to the preceding description or the following description. The holder comprises two mutually spaced brackets and dental floss held between the two brackets.

If, advantageously, a stop if arranged at an inner side of the holder formed between the two brackets and the dental floss, it is possible that the holder takes up only a small amount of installation space and, therefore, is easy to move in the mouth of the user.

A stop can be arranged at least at one of the two brackets, and so the introduction of the dental floss into an interdental space is limited in a vertical direction. Due to the stop, an injury of the gums can be reliably avoided, since the penetration depth of the dental floss into the interdental space preferably ends immediately before the gums are reached.

The holder comprises a second part of a form-locking and/or force-locked fastening system for connecting the holder to a base body of the dental cleaning system. The second part is preferably a fastening carriage or a fastening rail and/or a part of a magnetic, threaded, plug-in, adhesive, hook and loop, rotary, or snap-in connection.

Due to the holder, it is permitted to remove the dental floss from the dental cleaning system without the need to replace the entire dental cleaning system.

Advantageously, the fastening system is situated longitudinally or transversely with respect to the orientation of the dental floss.

According to the invention, the dental floss is tensioned between the two brackets when the holder is fastened to the base body.

It is advantageous when a stop is situated in an area formed between the two brackets, the dental floss, and an underside of the fastening carriage, and so an introduction of the dental floss into an interdental space is limited in a vertical direction.

A holder according to the invention for dental cleaning elements is also suitable, in particular, for an above-described dental cleaning system comprising dental floss. It is also suitable, however, as a holder for a dental cleaning element for cleaning the tooth surfaces or the interdental spaces, such as, in particular, dental floss, a toothpick, an interdental brush, or a toothbrush. Therefore, the holder can be universally used. It is equipped with different cleaning elements depending on the intended use.

Preferably, the holder is designed as one piece with a base body. Alternatively, the holder comprises a second part of a form-locking and/or force-locked fastening system, in particular, a fastening carriage or a fastening rail, to be accommodated in a base body of the dental cleaning system, and/or a part of a magnetic, threaded, plug-in, adhesive, hook and loop connection, or rotary connection and/or a part of a snap-in connection for connecting the holder to a base body of the dental cleaning system. In this two-pieced case, the base body can be connected to different holders comprising different cleaning elements.

Further advantages of the invention are described in the following exemplary embodiments. Wherein:

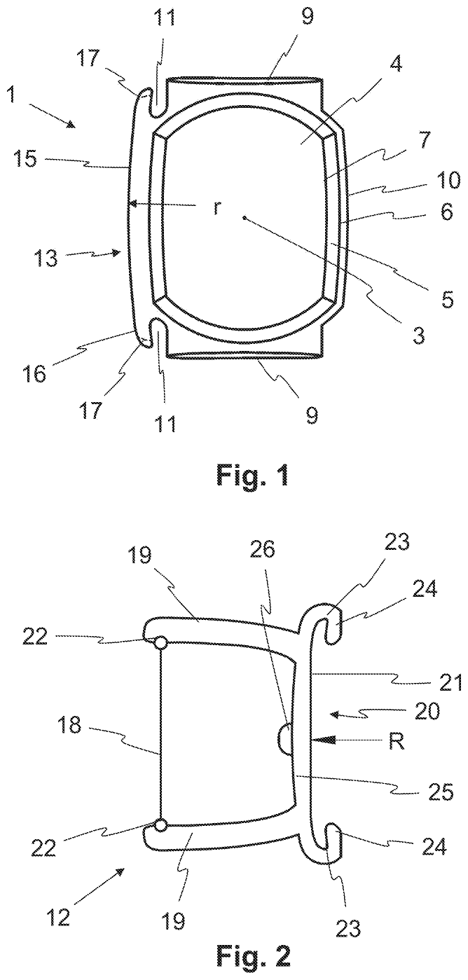

FIG. 1 shows a top view of a base body according to a first exemplary embodiment,

FIG. 2 shows a top view of a holder according to an exemplary embodiment,

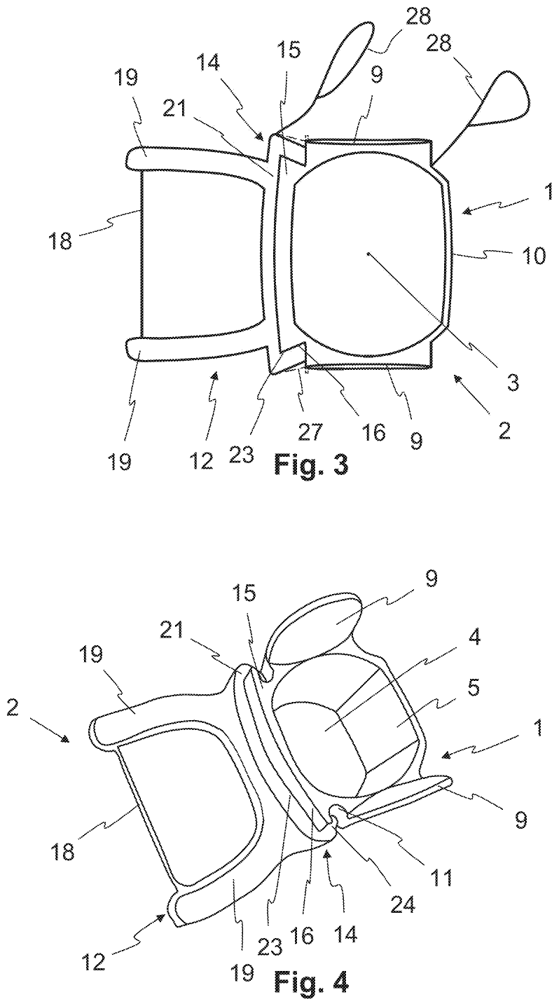

FIG. 3 shows a top view of a dental cleaning system comprising a base body and a holder according to an alternative exemplary embodiment,

FIG. 4 shows a perspective representation of the dental cleaning system according to a further exemplary embodiment,

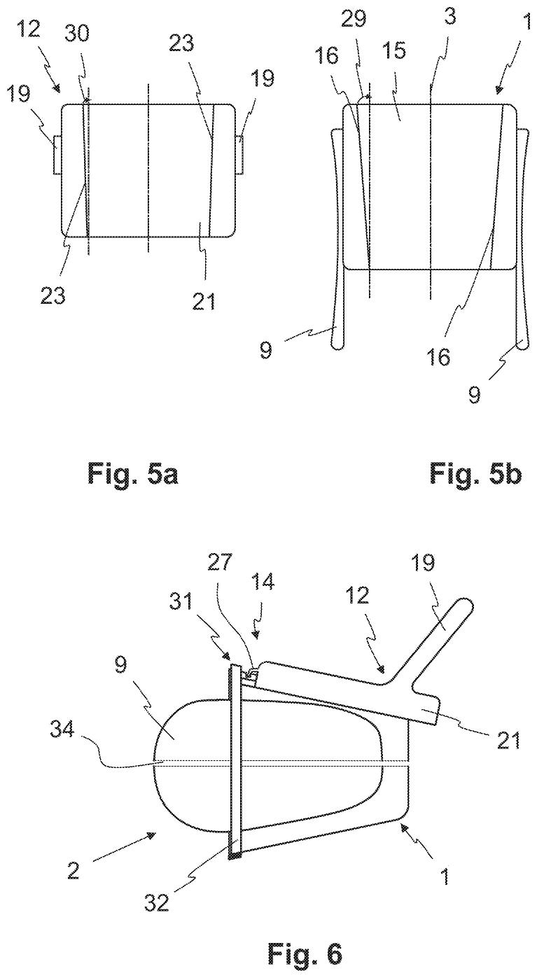

FIG. 5a shows a front view of the holder,

FIG. 5b shows a front view of the base body,

FIG. 6 shows a side view of the dental cleaning system according to a further embodiment,

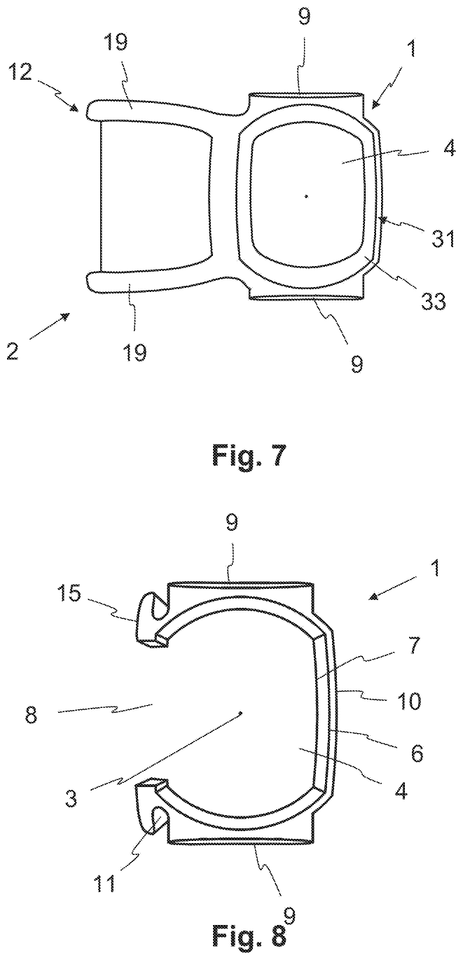

FIG. 7 shows a top view of the dental cleaning system according to an additional exemplary embodiment,

FIG. 8 shows a top view of the base body according to a further exemplary embodiment,

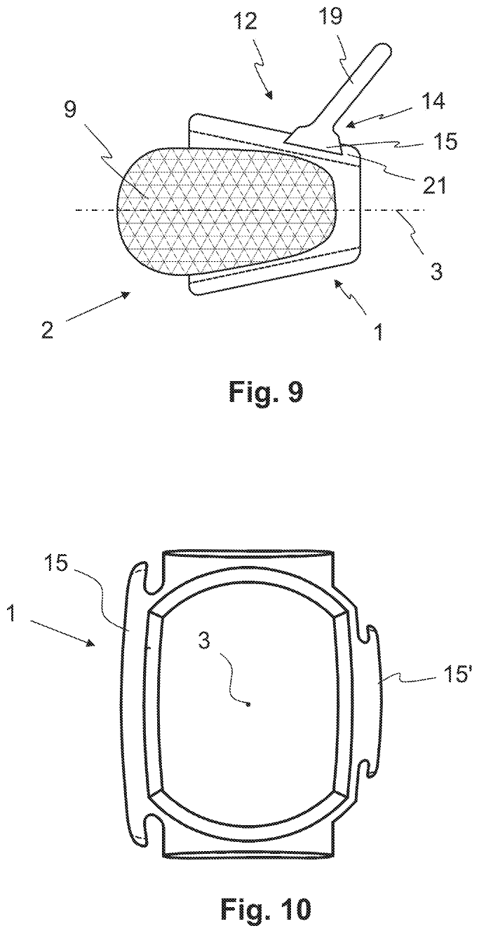

FIG. 9 shows a side view of the dental cleaning system according to an alternative embodiment,

FIG. 10 shows a top view of the base body according to a first exemplary embodiment similar to FIG. 1,

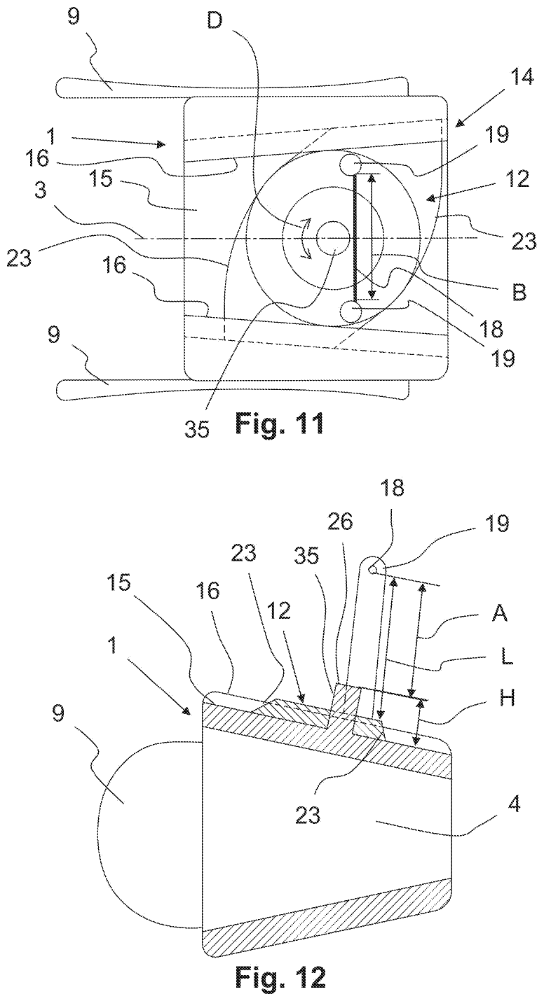

FIG. 11 shows a top view of a dental cleaning system according to a further exemplary embodiment,

FIG. 12 shows a section through a side view of the dental cleaning system similar to FIG. 11,

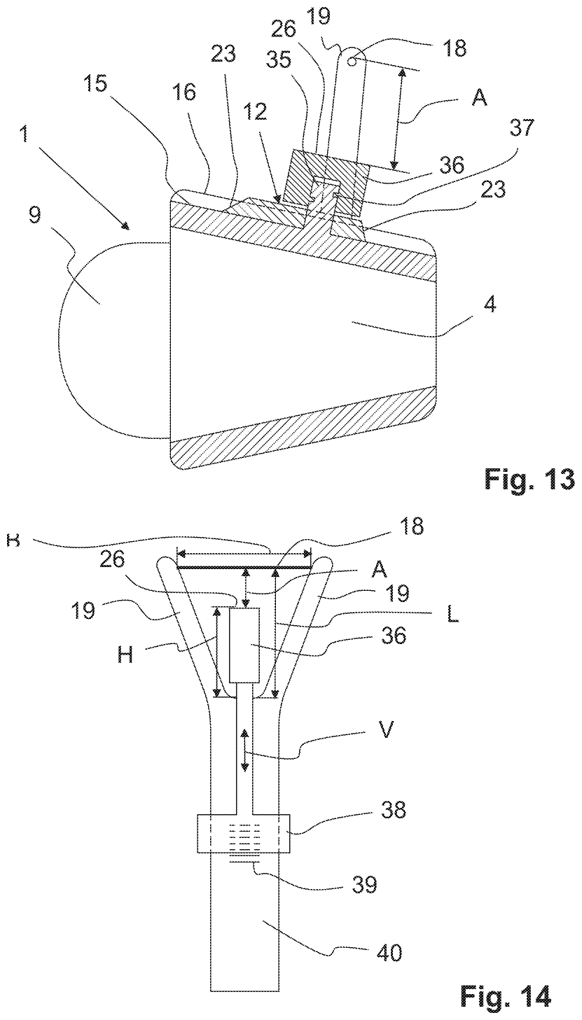

FIG. 13 shows a section through a side view of the dental cleaning system similar to FIG. 11,

FIG. 14 shows a top view of a dental cleaning system comprising a handle according to a further exemplary embodiment,

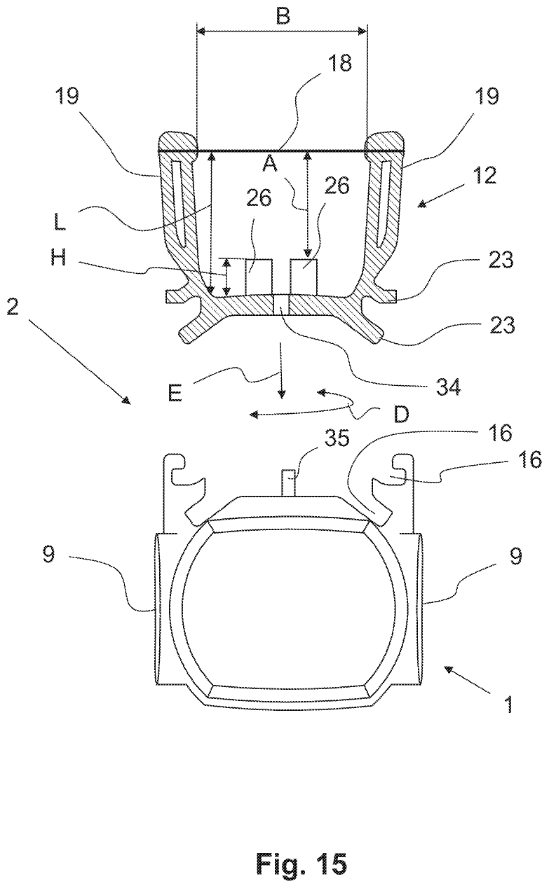

FIG. 15 shows a side view of the dental cleaning system according to an alternative, two-pieced embodiment,

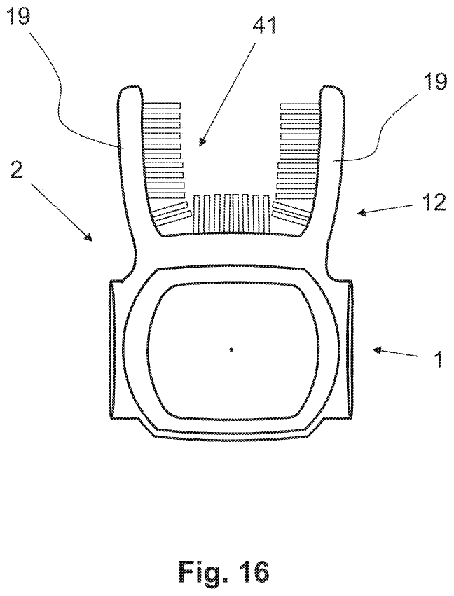

FIG. 16 shows a side view of the dental cleaning system according to an alternative, one-pieced embodiment, and

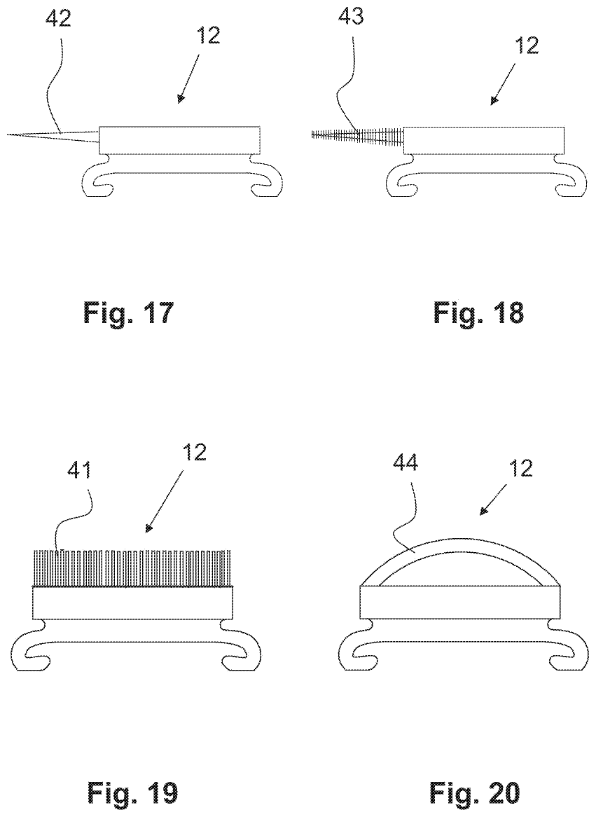

FIGS. 17 to 20 show side views of various dental cleaning elements at a holder in each case.

FIG. 1 shows a base body 1 for a dental cleaning system 2 according to the following FIGS. 3, 4, 6, 7, and 9. The base body 1 comprises a recess 4 extending in a longitudinal direction 3 for accommodating a fingertip (not represented). In FIG. 1, the longitudinal direction 3 extends into the sheet plane. The base body 1 is designed to be annular. The base body 1 can also be designed to be U-shaped (cf. FIG. 8).

The recess 4 comprises a conically shaped inner surface 5 and, therefore, a first recess opening 6 is larger than a second recess opening 7 offset along the longitudinal direction 3. Therefore, the recess 4 is designed to be essentially complementary to the finger. It would be conceivable that the recess 4 comprises only the first recess opening 6 and is designed in the shape of a thimble. The two recess openings 6, 7 can also have the same size, and so the recess is cylindrically shaped.

Recesses 4 having different sizes are made available for different finger shapes. Moreover, the inner surface 5 is designed to be polygonal, and so the base body 1 and, therefore, the dental cleaning system 2 according to FIGS. 3 and 4, is held in a rotatably fixed manner on the finger, in particular, the index finger.

The base body 1 has several, preferably four, sides. A first grip surface 9 is situated on each of two opposite sides. The two first grip surfaces 9 are provided for controlling the movement of the base body or of the dental cleaning system (cf. FIGS. 3, 4, 6, 7, and 9) in the oral cavity. Preferably, the thumb and the middle finger engage on the two first grip surfaces 9 in order to hold the base body 1. The two first grip surfaces 9 form a wing-type surface which projects over the base body 1. The first grip surface 9 extends along the longitudinal direction 3 of the base body 1.

A second grip surface 10 is provided between the two first grip surfaces 9. The second grip surface 10 is utilized as a further control surface for the thumb. One or several grip surfaces can include a non-slip surface in order to improve the feel during the handling. The grip surfaces 9, 10 can be curved, perforated, and/or ribbed.

The base body 1 comprises at least one slot 11 on its side opposite to the second grip surface 10. The slot 11 is designed for connecting the base body 1 to a holder 12 of the dental cleaning system 2. The slot 11 and the holder 12 are designed to be complementary to one another in such a way that the holder 12 can be at least partially accommodated by the slot.

The base body 1 comprises a first part 13 of a fastening system 14 (cf. FIGS. 3 and 4), with the aid of which the holder 12 can be positioned on the base body 1. According to FIG. 1, the first part 13 of the fastening system 14 is a fastening carriage 15. The fastening carriage 15 comprises a first guide surface 16 which is designed to be U-shaped. The fastening carriage 15 tapers in the longitudinal direction 3, as is represented in FIG. 1 with the aid of a dashed line 17. The fastening carriage 15 is therefore essentially conical, and so the widening area ensures that the fastening carriage 15 is braced against an area of the holder 12 provided therefor (cf. FIGS. 3 and 4).

FIG. 2 shows the holder 12 for the dental cleaning system 2 (cf. FIGS. 3, 4, 6, 7, and 9), which is designed, in particular, for connection to the base body 1 (cf. FIGS. 1, 8) and for tensioning dental floss 18. The holder 12 comprises two mutually spaced brackets 19, between which the dental floss 18 is held. The dental floss 18 is connected to the brackets 19 with the aid of at least one fastening element 22. Thus, for example, the dental floss 18 can be wound around the fastening element 22 and/or clamped therein. The dental floss 18 can also be fixedly connected to the brackets 19 or embedded therein, as is represented in FIGS. 3 and 4.

The holder 12 comprises a second part 20 of the fastening system 14, and so the holder 12 can be connected to the base body 1 (cf. FIGS. 1, 8) in a force-locked and/or form-locking manner. According to the present exemplary embodiment, the second part 20 of the fastening system 14 is a fastening rail 21 for accommodating the fastening carriage 15 of the base body 1. The fastening rail 21 comprises a second guide surface 23. The second guide surface 23 is designed to be U-shaped, and so the fastening carriage 15 of the base body 1 can be accommodated therein. A spring 24 is formed on the fastening rail 21, which engages into the slot 11 of the base body 1, and so, essentially, a groove-spring connection can be formed.

Between the two brackets 19 and the dental floss 18, a stop 26 is situated on an inner side 25 of the holder 12, and so the introduction of the dental floss 18 into the interdental space is limited. Holders 12 can be provided with different stops 26 or no stops 26 in order to ensure a gentle handling without injuring the individual gum.

The surface of the fastening carriage 15 (FIG. 1) has a convexity having a small radius r. The corresponding surface of the fastening rail 21 (FIG. 2) has a larger radius R, however. If the holder 12 and the base body 1 are connected to one another, a bending of the holder 12 occurs, whereby the two brackets 19 are bent apart from one another. A tensioning of the dental floss 18 results, which considerably facilitates the insertion of the dental floss 18 into the interdental space and the cleaning thereof. Such a movement of the brackets 19 can also be effectuated by way of an appropriate dimensioning of the slots 11 and the springs 24. In order to facilitate the connection of the fastening carriage 15 and the fastening rail 21, it can be provided that a large amount of play is initially provided, which finally decreases and, thus, results in a clamping only upon further insertion of the spring 24 into the slot 11.

FIG. 3 shows the dental cleaning system 2 comprising the base body 1 and the holder 12, each according to one alternative embodiment. In contrast to the base body 1 shown in FIG. 1 and the holder 12 shown in FIG. 2, the two guide surfaces 16, 23 are designed in a dovetail shape in this case.

The guide surfaces 16, 23 of the base body 1 and of the holder 12, respectively, are not parallel to one another in the non-assembled state, as is represented in FIGS. 1 and 2. When the holder 12 or its fastening rail 21 is slid onto the fastening carriage 15 or the base body, the holder 12 spreads apart in such a way that the dental floss 18 is tensioned between the brackets 19. Therefore, when the holder 12 and the base body 1 are not connected to one another to form the dental cleaning system 2, the dental floss 18 is essentially held loosely between the brackets 19. The dental floss 18 is first tensioned by way of the connection of the two parts 13, 20 of the fastening system, in particular, the connection of the fastening carriage 15 to the fastening rail 21. The tension of the dental floss is established in such a way that an ideal cleaning of the interdental spaces can take place.

According to FIG. 3, the dental floss 18 is fixedly connected to the brackets 19, wherein one end of the dental floss 18 is molded into a bracket 19 in each case. Alternatively, as represented in FIG. 2, the dental floss 18 can be fastened to the holder 12 with the aid of the fastening element, and so the dental floss 18 can be replaced at any time, as necessary. In order to replace the dental floss 18, according to FIG. 3, on the dental cleaning system 2, the holder 12 is removed from the dental cleaning system 2 and a new holder (not represented) is connected to the base body 1.

The fastening system 14 of the dental cleaning system 2 is additionally secured with the aid of a locking mechanism 27 which is merely schematically indicated in FIG. 3. The locking mechanism 27 can be designed, for example, to include a magnet, a snap-in connection, or a push button.

Moreover, a retaining element 28 is installed on the dental cleaning system 2, which safeguards the holder 12 and/or the base body 1 against being swallowed. The retaining element 28 is designed as a thread which can be fastened on the hand and is fastened to the holder 12 and/or the base body 1.

FIG. 4 shows a perspective representation of the dental cleaning system 2. The base body 1 and the holder 12 are connected to one another by the fastening system 14, in particular, the fastening carriage 15 has been slid into the fastening rail 21. Since the guide surfaces 16, 23 (cf. FIGS. 1 and 2) extend askew with respect to one another, the holder 12 spreads apart on the base body 1 in such a way that the dental floss 18 is tensioned.

The inner surface 5 of the base body is designed to be conical and polygonal, and so the entire dental cleaning system 2 is held on the finger in a rotatably fixed manner when the dental cleaning system 2 is utilized, in particular, in the oral cavity. Preferably, different sizes and geometries of the dental cleaning system 2 are made available for different finger shapes. Thus, smaller dental cleaning systems 2 are also suitable for small fingers, wherein, in particular, the recess 4 of the base body 1 is reduced in size.

FIG. 5a shows the holder 12 as well as its second guide surface 23 and FIG. 5b shows the base body 1 comprising the first guide surface 16. The geometry of the second guide surface 23 can differ from the geometry of the first guide surface 16. In this case, the two guide surfaces 16, 23 are not parallel to one another, in particular, when the holder 12 is situated with respect to the base body 1 in such a way that the two guide surfaces 16, 23 face one another. As a result, a spreading or clamping of the holder 12 on the base body 1 can be achieved.

As is also described according to FIG. 1, the first guide surface 16 is designed to be conical, wherein the fastening carriage 15 describes a first taper angle 29. The second guide surface 23 can also be designed to be conical, although preferably having a smaller second taper angle 30. When the fastening carriage 15 is slid into the fastening rail 21, the larger first guide surface 16, due to its larger first taper angle 29, spreads the smaller second taper angle 30 or the second guide surface apart, and so the dental floss 18 (cf. FIGS. 3, 4, 7, 9) is tensioned.

One of the taper angles 29, 30 can be equal to zero in this case, and so the guide surface is essentially straight.

FIG. 6 shows a side view of the dental cleaning system 2 which is equipped with an adjusting mechanism 31. According to FIG. 6, the adjusting mechanism 31 is designed as a size-adjustable tube clamp 32 for varying the diameter of the recess 4. Due to the fact that the tube clamp 32 is fixed, the recess 4 of the base body 1 reduces in size, and so the dental cleaning system 2 is suitable for smaller fingers. The base body 1 is provided with a slot 34 in order to make it easy to reduce the size of the base body 1. The diameter of the base body 1 can be reduced by tightening the tube clamp 32.

In addition to the adjusting mechanism 31, FIG. 6 shows that the brackets 19 of the holder 12 are situated obliquely with respect to the fastening rail 21 thereof and with respect to the longitudinal axis 3 of the base body 1.

In FIG. 6, another locking mechanism 27 for the holder 12 on the base body is also represented, in a sketched manner. This is a small tab which snaps into a recess in the base body 1. An inadvertent release of the connection between the base body 1 and the holder 12 is therefore avoided. For the purpose of releasing the connection, it can be provided that the tab breaks at an intended breaking point in order to indicate that the dental floss has already been used and should not be used once again.

FIG. 7 shows that the base body 1 and the holder 12 are connected to one another as one piece to form the dental cleaning system 2. The dental cleaning system 2 therefore does not comprise a fastening system 14 according to the preceding figures. In order to ensure that the entire dental cleaning system 2 does not need to be replaced when the dental floss 18 is replaced, the dental cleaning system 2 can comprise a fastening element 22 according to FIG. 2. The fastening element 22 makes it possible to replace only the dental floss 18.

Moreover, an alternative embodiment of the adjusting mechanism is formed in the recess 4, which is a ring insert 33 according to FIG. 7.

The ring insert 33 is separately formed and can be placed into the recess in order to reduce the size of the recess. In this way, the dental cleaning system 2 is easily adapted to different finger shapes and sizes.

FIG. 8 shows the base body 1 according to an alternative embodiment, wherein the base body 1 is designed to be U-shaped. The base body 1 comprises a third recess opening 8 which is situated in the area of the fastening carriage 15. It is also conceivable that the recess opening 8 is situated on the other sides of the base body 1.

FIG. 9 shows that the fastening system 14 can also be oriented transversely with respect to the longitudinal direction 3 of the base body. In order to connect the fastening carriage 15 and the fastening rail 21 to one another, the holder 12 is slid onto the base body 1 transversely with respect to the longitudinal direction 3.

Due to a predefined, different bending of the fastening carriage 15 and the fastening rail 21 in the insertion direction, a pre-tensioning of the dental floss 12 arises, since the brackets 19 move away from one another, at the end thereof to which the dental floss is fastened (see FIG. 2). In the relaxed state, before the fastening carriage 15 has been slid into the fastening rail 21, the radius of the fastening carriage 15 is greater than the radius of the fastening rail 21. In contrast to the preceding figures, the base body 1 comprises the fastening rail 21 and the holder 12 comprises the fastening carriage 15. In this FIG. 9, it is also indicated that the surface of the grip surface is structured, specifically, ribbed in this case, in order to improve the guidance of the dental cleaning system 2.

FIG. 10 shows a base body 1 similar to FIG. 1. The only difference is that a second fastening carriage 15′ is provided in addition to the fastening carriage 15. The second fastening carriage 15′ is dimensioned smaller in this case and, therefore, is suitable for the accommodation of a smaller holder according to FIG. 2. Of course, a second accommodation similar to the embodiment according to FIG. 9 can also be situated transversely with respect to the longitudinal direction 3 of the base body 1 or even a combination of both types of the accommodation.

In FIG. 11, a top view of a dental cleaning system according to a further exemplary embodiment is represented. In this top view, the base body 1 comprising the two first grip surfaces 9 is shown. The fastening carriage 15 as well as the first guide surface 16 of the fastening system 14 are arranged at the base body 1. While the holder 12 was connected to the base body 1 with the aid of a linear movement in the preceding exemplary embodiments, a rotary motion is necessary in this exemplary embodiment, in order to fasten the holder 12 at the base body 1. The holder 12 comprises two brackets 19, at which the dental floss 18 is fastened. In order to insert the holder 12 into the base body 1, the holder 12 is rotated toward the right, in the double-arrow direction D, by approximately 90° with respect to the representation shown here and is inserted onto a centering pin 35 of the base body 1. Thereafter, the holder 12 is rotated toward the left, in the double-arrow direction D again, by approximately 90° around the centering pin 35 and on the fastening carriage 15 and becomes fixed, for example, in a dovetail groove of the first guide surface 16. The second guide surface 23 of the holder 12 corresponds to the first guide surface 16 of the base body 1.

Due to this fastening of the holder 12 on the base body 1, either the holder 12 is bent in such a way that the brackets 19 are slightly spread apart at their upper ends, whereby the dental floss 18 is tensioned across its effective length B. Alternatively, only the area at which the brackets 19 are fastened at the holder 12 can also be elastically deformed with respect to the holder 12 and also spread the brackets 19 apart with the aid of appropriate guide surfaces. The effective length B of the dental floss 18 for cleaning the interdental space is also located in the intermediate space between the two brackets 19 and, therefore, is tensioned.

FIG. 12 shows a section through a side view of the dental cleaning system similar to FIG. 11. In this case, the centering pin 35, which is part of the base body 1, is apparent again. Of course, conversely, the centering pin 35 could also be part of the holder 12 and could be introduced into an opening of the base body 1. The first guide surface 16 and the second guide surface 23 cooperate, and so the holder 12 is fixed on the base body 1. At the holder 12, in this sectional representation, one of the two brackets 19 as well as a section through the dental floss 18 are apparent.

The centering pin 35 extends with a height H past the top side of the second guide surface 23 of the holder 12, whereby the distance A between the centering pin 35 and the dental floss 18 is determined. This distance A is less than the distance would be between the dental floss 18 and the top side of the holder 12, which the tooth would impact without the stop 26. The distance A therefore forms a dimension representing how far the dental floss can penetrate the interdental space. When the dental floss 18 is introduced into an interdental space, the stop 26 impacts the top side of the tooth and, therefore, limits the penetration depth of the dental floss 18. Depending on the individual jaw of the user, the distance A can be individually adapted, as a result, with the aid of various base bodies 1 having centering pins 35 of different lengths. Alternatively, it is also possible to make different holders 12 available, in the case of which the brackets 19 have a different length L. The length L of the brackets 19 is determined in this case as the distance between the dental floss 18 and the fastening of the bracket 19 at the holder 12 or, according to other exemplary embodiments, at the base body 1. As a result thereof as well, the distance A with respect to a stop 26 of the centering pin 35 or the top side of the holder 12 in the area of the two brackets 19 is individually set to the needs of the user.

In the exemplary embodiment from FIG. 13, which shows a section through a side view of the dental cleaning system similar to FIG. 11, the stop 26 is formed by a stop piece 36. The stop piece 36 has been inserted onto the centering pin 35 and, there, determines the distance A of the stop 26 from the dental floss 18.

In this exemplary embodiment, the height H of the stop piece 36 can be adjusted, in height, with respect to the dental floss 18. This can take place either with the aid of various notches, wherein the stop piece 36 is inserted onto the centering pin 35 to a more or less deep extent. Alternatively, it is also possible, as represented here, that a thread 37 or an appropriate inclined surface is provided. The stop piece 36 is screwed onto the centering pin 35 and, as a result, changes the height H with respect to the top side of the holder 12 or the distance A to the dental floss 18. In this case as well, in a further alternative, it is possible that the brackets 19 of the holder 12 are designed to be longitudinally adjustable and become more or less long, for example, with the aid of telescopic displacement and, as a result, affect the distance A.

FIG. 14 shows a top view of a dental cleaning system comprising a handle 40 according to a further exemplary embodiment. This is a conventional dental cleaning system comprising a handle 40 and two brackets 19 designed in the shape of a fork, between which the dental floss 18 is tensioned. The stop 26 comprising a stop piece 36 for a tooth is fastened at a displacement part 38. The displacement part 38 is displaceable according to the direction of the double arrow V. As a result, the distance A between the dental floss 18 and the stop 26 or the height H between the top side of the stop piece 36 and the lowest point of the handle 40 between the brackets 19, at which a tooth would impact, is determined. In order to retain the selected distance A, the handle 40 comprises notches 39, which correspond to the displacement part 38. The displacement of the displacement part 38 therefore requires a certain amount of force, which prevents the distance A from being inadvertently changed. Alternatively, the effective length L of the brackets 19 can also be changed, for example, with the aid of a telescopic embodiment (not represented) of the brackets 19.

In order to utilize fewer plastics and, therefore, to reduce the burden on the environment, it can be provided that the holder 12 and/or the base body 1 and/or the stop 26 are/is manufactured from a renewable and, in particular, consumable raw material. Therefore, the risk of an injury to a user is also avoided in the case of inadvertent swallowing. In addition, if it also provided that good-tasting material is utilized, for example, for the application for children, an incentive to use the dental cleaning system can be created. After cleaning the interdental space, the user can eat the dental cleaning system or at least parts thereof. It is also advantageous when the material of the dental cleaning system is bio-compostable. This contributes to a considerable reduction of plastic waste.

FIG. 15 shows a side view of the dental cleaning system 2 according to an alternative, two-pieced embodiment. The dental cleaning system 2 comprises the base body 1 and the holder 12. The holder 12 can be connected to the base body 1, in that it is inserted onto the base body 1 in the insertion direction E and, thereafter, is rotated in direction of rotation D. As a result, a two-pieced fastening system locks in position, in the case of which two first guide surfaces 16 and two second guide surfaces 23, on each side of the holder 12, are connected to each other. While the first, lower guide surface 16, together with the second, lower guide surface 23, brings about a strong hold between the holder 12 and the base body 1, the upper guide surfaces 16 and 23 cause the brackets 19 to spread apart and, therefore, tension the dental floss 18.

Moreover, in this exemplary embodiment, it is apparent that two stops 26 are arranged at the holder 12. As a result, a distance A for the dental cleaning system 2 is created, and so the dental floss 18 cannot cut into the gums, since it is stopped as soon as the stops 26 impact the tooth surface. The distance A can be determined by the height H of the stops 26 or by the effective length L of the brackets 19.

The holder 12, which is represented in cross section in this exemplary embodiment, shows that the brackets 19 are designed in a reinforced manner. Accordingly, they comprise two sections extending essentially in parallel, which facilitate the manufacture, on the one hand, and, on the other hand, create an additional stability for the fastening and tensioning of the dental floss 18.

In FIG. 16, a side view of the dental cleaning system 2 according to an alternative, one-pieced embodiment is shown. In this embodiment, a toothbrush 41 is arranged at the brackets 19 and at the intermediate space between the two brackets 19 at the holder 12. Similarly to the dental floss 18, the toothbrush 41 can be optimally guided with the aid of the fingers by the holder 12 according to the invention and the base body 1. As a result, a very positive cleaning effect is achieved.

FIGS. 17 through 20 show side views of various dental cleaning elements at a holder 12 in each case. In FIG. 17, a toothpick 42 is arranged at the holder 12. FIG. 18 comprises an interdental brush 43 at the holder 12. The arrangement of the dental cleaning elements can also be on the top side or the other side of the holder 12, in deviation from the representation in the present case. The angle of the arrangement can also not be 90°, as represented here, but rather can be an acute or obtuse angle.

In FIG. 19, a type of the toothbrush 41 is represented that is modified as compared to FIG. 16. In FIG. 20, a tongue cleaner 44 is fastened at the holder 12. The tongue cleaner 44 can comprise a rough surface.

The holders 12 shown here can each be combined with a base body 1. Of course, it is also possible that these dental cleaning elements are arranged in a one-pieced design of the dental cleaning system 2.

The present invention is not limited to the represented and described exemplary embodiments. Modifications within the scope of the claims, for example, by arranging the stop at the brackets or at the base body, are also possible, as is any combination of the features, even if they are represented and described in different exemplary embodiments. It is also possible, in particular, to differently establish the angle between the handle or the base body and the brackets, at which the dental floss is fastened, as necessary. It is merely important that the stop is arranged in such a way that it can prevent an injury of the gums. For the rest, it is also possible, of course, that the invention or parts thereof is/are utilized on manually utilized dental cleaning systems, as well as on toothbrushes, electric toothbrushes, electric dental cleaning systems, or interdental brushes.

### LIST OF REFERENCE CHARACTERS

1 base body
2 dental cleaning system
3 longitudinal direction
4 recess
5 inner surface
6 first recess opening
7 second recess opening
8 third recess opening
9 first grip surface
10 second grip surface
11 slot
12 holder
13 first part
14 fastening system
15 fastening carriage
16 first guide surface
17 line
18 dental floss
19 bracket
20 second part
21 fastening rail
22 fastening element
23 second guide surface
24 spring
25 inner side
26 stop
27 locking mechanism
28 retaining element
29 first taper angle
30 second taper angle
31 adjusting mechanism
32 tube clamp
33 ring insert
34 centering opening
35 centering pin
36 stop piece
37 thread
38 displacement part
39 notch
40 handle
41 toothbrush
42 toothpick
43 interdental brush
44 tongue cleaner
A distance
D double-arrow direction of rotation
E insertion direction
V double-arrow direction of displacement
r small radius
R large radius
B effective length of the dental floss
H height
L length of the bracket

1-30. (canceled)

31. A dental cleaning system, comprising:
a holder for dental floss, the holder comprising two mutually spaced brackets with a dental floss held therebetween;
a base body defining a recess situated in a longitudinal direction of the base body for accommodating a fingertip slid into the base body;
the brackets extending transversely with respect to the longitudinal direction of the base body;
first grip surfaces situated on each of opposite sides of the base body; and
wherein the first grip surfaces provide for controlling movement of the dental floss in a mouth of a user with aid of fingers adjacent to the base body.

32. The dental cleaning system of claim 31, further a second grip surface provided on a side of the base body opposite to the brackets, the second grip surface providing control of the movement of the dental floss with aid of the thumb or index finger.

33. The dental cleaning system of claim 32, wherein the first grip surfaces and the second grip surface are formed as one of a wing-like projection over th base body or a non-slip surface having a curved, perforated, or ribbed surface.

34. The dental cleaning system of claim 31, wherein the holder is separate from and connected to the base body with a fastening system.

35. The dental cleaning system of claim 34, wherein the base body comprises a slot that accommodates the holder.

36. The dental cleaning system of claim 34, wherein the fastening system comprises a first part configured on the main body and a second complimentary part configured on the holder, the first and second parts connecting in such a manner so as to flex the brackets to create tension in the dental floss held by the holder upon connecting the holder to the base body

37. The dental cleaning system of claim 36, wherein the first part and the second part engage in a form-locking configuration to connect the holder to the base body.

38. The dental cleaning system of claim 36, comprising a releasable locking mechanism that secures the holder to the base body in the form-locking configuration.

39. The dental cleaning system of claim 34, wherein the first part comprises a fastening carriage and the second part comprises a fastening rail, the fastening carriage and the fastening rail comprising a tapered profile in a longitudinal or transverse direction of the base body.

40. The dental cleaning system of claim 39, comprising complementary U-shaped or dovetail-shaped guide surfaces configured on the fastening carriage and fastening rail that, the guide surfaces engaging as the fastening rail and the fastening carriage slide together to connect the holder to the base body.

41. The dental cleaning system of claim 40, wherein the guide surfaces are formed such that the brackets on the holder are caused to spread apart upon connecting the holder to the body to tension the dental floss upon.

42. The dental cleaning system of claim 31, further comprising a retaining element configured on one or both of the holder and the base body to the holder or the base body from being swallowed.

43. The dental cleaning system of claim 31, further comprising a stop that extends into an area between the brackets and between the dental floss and the base body, wherein the stop limits a depth of introduction of the dental floss into an interdental space in a vertical direction.

44. The dental cleaning system of claim 43, wherein a distance (A) of the dental floss from the stop is less than 12 mm.

45. The dental cleaning system of claim 44, wherein a ratio of the distance (A) of the dental floss from the stop relative to an effective length (B) of the dental floss is less than or equal to 0.5.

46. The dental cleaning system of claim 31, wherein a stop is formed between the brackets by the holder of the base body such that a length of the brackets limits a depth of introduction of the dental floss into an interdental space in a vertical direction.

47. The dental cleaning system of claim 31, further comprising a fastening element on the brackets to hold the dental floss between the brackets.

48. The dental cleaning system of claim 31, wherein one or both of the holder and the base body comprise a visual coding characteristic that conveys to a user size of the dental cleaning system or type of dental floss.

49. The dental cleaning system of claim 31, wherein one or both of he holder and the base body are formed from a consumable raw material,

50. A base body configured for attachment to a dental floss holder in a dental cleaning system, comprising:
an annular or U-shaped configuration defining a recess situated in a longitudinal direction of the base body for accommodating a fingertip slid into the base body; and
first grip surfaces situated on each of opposite sides of the base body to control movement of a dental floss on the dental floss holder in a mouth of a user with aid of fingers adjacent to the base body.

51. The base body of claim 50, further comprising further a second grip surface provided on a side of the base body that extends between the first grip surfaces, the second grip surface configured to provide control of the movement of he dental cleaning element with aid of a thumb or index finger.

52. The base body of claim 50, wherein the first grip surfaces form wing-like projections over the base body.

53. The base body of claim 50, comprising a first component of a form-locking fastening system formed on the base body, wherein the first component engages with a complementary second component formed on the dental floss holder.

54. The base body of claim 50, wherein the recess comprises a flattened or conical profile to hold the bade body on the fingertip in a rotationally fixed manner.

55. The base body of claim 50, further comprising a slot defined therein configured to slidingly engage with the dental floss holder.

56. The base body of claim 50 is formed as one of: a U-shaped member;
a closed ring member; an open ring member; or a thimble member.

57. A holder for a dental cleaning element, the holder configured for attachment to a base body of a dental cleaning system, comprising:
two spaced-apart brackets with a dental cleaning element held by the brackets;
a first component of a form-locking or force-locking fastening system used to attach the holder to the base body, the first component engaging with a complimentary second component on the base body; and
wherein the first component is configured such that upon engagement with the second component on the base body, the brackets flex to create tension in the dental floss held between the brackets.

58. The holder of claim 57, wherein the first component is oriented longitudinally or transversely with respect to orientation of the dental floss.

59. The holder of claim 57, further comprising a stop formed between the two brackets, the stop boated to limit vertical introduction of the dental cleaning element into an interdental space.

60. The holder of claim 57. wherein the dental cleaning element comprises dental floss.

61. The holder of claim 57, wherein the dental cleaning element comprises one of: a toothpick, an interdental brush, or a toothbrush.
